(19) United States
(12) Patent Application Publication
(10) Pub. No.: US 2018/0076706 A1
(43) Pub. Date: Mar. 15, 2018

(54) Accumulator System For Electrical Energy

(71) Applicant: Siemens Aktiengesellschaft, Muenchen (DE)

(72) Inventors: Christopher BETZIN, Forchheim (DE); Jacob Johan RABBERS, Son en Breugel (NL); Holger WOLFSCHMIDT, Erlangen (DE)

(73) Assignee: Siemens Aktiengesellschaft, Muenchen (DE)

(21) Appl. No.: 15/553,339

(22) PCT Filed: Jan. 19, 2016
(86) PCT No.: PCT/EP2016/050978

§ 371 Date: Aug. 24, 2017

(30) Foreign Application Priority Data
Feb. 24, 2015 (DE) 10 2015 203 269.8

(51) Int. Cl. H02M 1/32; H02M 7/46

(52) U.S. Cl. CPC H02M 1/32; H02M 2001/327; H02M 7/46

(57) ABSTRACT

The present disclosure relates to accumulating electrical energy and the teachings thereof may be embodied in accumulator systems and methods. For example, an accumulator system may comprise: an energy accumulator for generating a DC voltage; a converter for converting the DC voltage into an AC voltage, connected to the energy accumulator via an intermediate circuit; and a diode in the intermediate circuit connected in parallel with the energy accumulator and the converter. The diode may have reverse bias to limit a voltage in the intermediate circuit.

### CROSS-REFERENCE TO RELATED APPLICATIONS

This application is a U.S. National Stage Application of International Application No. PCT/EP2016/050978 filed Jan. 19, 2016, which designates the United States of America, and claims priority to DE Application No. 10 2015 203 269.8 filed Feb. 24, 2015, the contents of which are hereby incorporated by reference in their entirety.

### TECHNICAL FIELD

The present disclosure relates to accumulating electrical energy and the teachings thereof may be embodied in accumulator systems and methods.

### BACKGROUND

Use of accumulator systems dictates a high safety standard during operation, and the provision of protective mechanisms in the event of a malfunction. The connection of an energy accumulator, in the form of a DC voltage source or sink, to an AC voltage network is typically completed via an inverter. An intermediate DC voltage circuit may be arranged between the energy accumulator and the inverter, in which overvoltages can occur. Currently existing methods for the protection of the intermediate circuit, the energy accumulator and the inverter employ contactors, which open in the event of a malfunction. These contactors are electrically actuated by means of a controller, using appropriate software, and are tripped upon the overshoot of a given voltage level, to prevent damage to both the inverter and the energy accumulator.

### SUMMARY

The teachings of the present disclosure may be embodied in an accumulator system for accumulating electrical energy which, by simple means, can protect both an energy accumulator and a converter against an overvoltage. For example, some embodiments may include an accumulator system (100) for accumulating electrical energy having: an energy accumulator (101) for generating a DC voltage; a converter (103) for converting the DC voltage into an AC voltage, which is connected to the energy accumulator (101) via an intermediate circuit (105); and a diode (107), which is connected in the intermediate circuit (105) in parallel with the energy accumulator (101) and the converter (103), with reverse bias, so as to limit a voltage in the intermediate circuit (105).

In some embodiments, the accumulator system (100) incorporates a further diode (107) for limiting the voltage in the intermediate circuit (105), which is connected in the intermediate circuit (105) in parallel with the energy accumulator (101) and the converter (103), with reverse bias.

In some embodiments, the diode (107) is a semiconductor diode with a p-n junction, or a Schottky diode.

In some embodiments, the accumulator system (100) incorporates a resistor (109), which is connected in series with the diode (107). In some embodiments, the resistor (109) has a rating of between 0.1Ω and 100Ω, preferably between 1Ω and 10Ω.

In some embodiments, the diode (107) is a high-current diode having a permissible breakdown current greater than 60 A. In some embodiments, the diode (107) is a Zener diode, an avalanche diode or a suppressor diode. In some embodiments, the accumulator system (100) incorporates further Zener diodes, which are connected in series with the Zener diode (107).

In some embodiments, the accumulator system (100) incorporates a DC voltage converter, in order to increase the DC voltage of the energy accumulator (101).

In some embodiments, the diode (107) incorporates a cooling arrangement.

In some embodiments, cooling is achieved by the contact of the diode (107) with a heat sink.

In some embodiments, the accumulator system (100) incorporates further diodes, which are connected in parallel.

### BRIEF DESCRIPTION OF THE DRAWINGS

Exemplary embodiments are represented in the drawings, and are described in greater detail hereinafter. Herein:

FIG. 1 shows a view of an accumulator system according to teachings of the present disclosure; and

FIG. 2 shows a characteristic curve of a diode.

### DETAILED DESCRIPTION

In some embodiments, an accumulator system for accumulating electrical energy may include an energy accumulator for generating a DC voltage; a converter for converting the DC voltage into an AC voltage, which is connected to the energy accumulator via an intermediate circuit; and a diode, which is connected in the intermediate circuit, in parallel with the energy accumulator and the converter, with reverse bias, so as to limit a voltage in the intermediate circuit. By the use of a diode operating with reverse bias in a parallel circuit connection between the energy accumulator and the converter, the intermediate circuit can be passively protected. Monitoring of the voltage by means of voltage measurement, controllable contactors and a controller with software can be omitted.

In some embodiments, the accumulator system incorporates a further diode for limiting the voltage in the intermediate circuit, which is connected in the intermediate circuit in parallel with the energy accumulator and the converter, with reverse bias. Thus, the power applied to a diode in the event of an overvoltage is reduced, and redundant overvoltage protection is achieved.

In some embodiments, the diode is a semiconductor diode with a p-n junction, or a Schottky diode. Thus, overvoltages in the intermediate circuit can be efficiently dissipated.

In some embodiments, the accumulator system incorporates a resistor, which is connected in series with the diode. Thus the power applied in the event of an overvoltage is not applied to the diode in full. In some embodiments, the resistor has a rating of between 0.1Ω and 100Ω, preferably between 1Ω and 10Ω. Thus, damage to the diode associated with high power is prevented.

In some embodiments, the diode is a high-current diode having a permissible breakdown current greater than 60 A. Thus, even overvoltages at high currents can be short-circuited, with no resulting damage to the diode.

In some embodiments, the diode is a Zener diode, an avalanche diode, or a suppressor diode. Thus, efficient voltage stabilization is achieved.

In some embodiments, the accumulator system incorporates further Zener diodes, which are connected in series with the Zener diode. Thus, the breakdown voltage is increased.

In some embodiments, the accumulator system incorporates a DC voltage converter, in order to increase the DC voltage of the energy accumulator. Thus, the voltage of the energy accumulator available for the converter can be increased.

In some embodiments, the diode incorporates a cooling arrangement. Thus, damage to the diode by heat can be prevented. In some embodiments, cooling is achieved by the contact of the diode with a heat sink. Thus, cooling can be achieved with limited complexity.

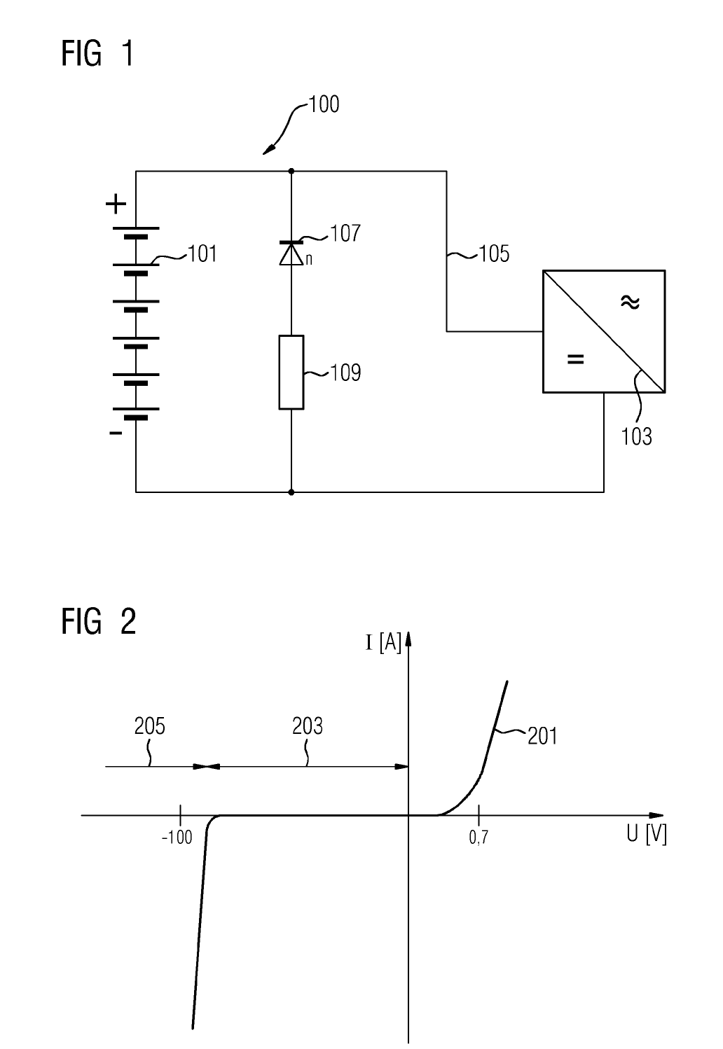

FIG. 1 shows a view of an accumulator system 100 for accumulating electrical energy according to teachings of the present disclosure. The accumulator system 100 comprises an energy accumulator 101 for generating a DC voltage, a converter 103 for converting the DC voltage into an AC voltage, which is connected to the energy accumulator 101 via an intermediate circuit 105; and a diode 107, which is connected in the intermediate circuit 105 in parallel with the energy accumulator 101 and the converter 103, with reverse bias, so as to limit a voltage in the intermediate circuit 105. The converter is, for example, an inverter, for the conversion of the DC voltage into an AC voltage. Accordingly, the diode 107 is parallel-connected, with reverse bias, in the intermediate circuit 105 comprising the energy accumulator 101 and the converter 107.

The energy accumulator 101 can be a mechanical, electrical, electrochemical or chemical energy accumulator, and/or a thermal store. A mechanical energy accumulator may comprise, for example, a flywheel, a pumped storage power plant or a hydraulic accumulator. An electrical or electrochemical energy accumulator 101 may comprise, for example, a super-capacitor, and/or a battery. A chemical energy accumulator 101 may employ, for example, hydrogen, methane, and/or methanol. Conversely, a thermal store may employ steam, hot water, PCM materials, and/or molten carbonates. In the case of non-electrical energy storage, the DC voltage may be generated by means of a converter device. If, for example, energy is stored in the motion of a flywheel, a generator can be employed for the generation of a rectified voltage from kinetic energy.

The diode 107 in the intermediate circuit 105 may comprise a p-n-doped semiconductor crystal junction or a metal semiconductor junction (Schottky diode). The diode 107 may comprise a Zener diode. In this case, a series-connected arrangement of Zener diodes may achieve the necessary breakdown voltage. The converter 103 may comprise, for example, an inverter, and/or a DC-AC converter, for the conversion of the direct current into an alternating current at a predetermined frequency.

The accumulator system 100 may comprise a combination of a diode 107 and a resistor 109, such that the full power is not applied to the diode 107. The resistor 109 employed may have a rating of between 1Ω and 10Ω. This range can be extended to between 0.1Ω and 1Ω, and to between 10Ω and 100Ω. Resistors of rating smaller than 0.1Ω and greater than 100Ω are also possible.

The diode 107 functions as a passive overvoltage protection device, to limit the voltage in the intermediate circuit. A diode 107 operated with reverse bias in a parallel-connected arrangement between the energy accumulator 101 and the converter 103 may provide passive protection to the intermediate circuit 105. This constitutes an overvoltage protection function, which is ensured until the breakdown voltage of the diode 107 is overshot. Upon the overshoot of the breakdown voltage, the diode 107 becomes conductive, and functions as a bypass. The voltage in the intermediate circuit 105 or the energy accumulator 101 does not rise any further, and the excess current flows in the diode 107.

By means of the diode 107, both the maximum voltage on the accumulator system 100 is limited and the passage of an in-service bypass current in the diode 107 is also possible. Consequently, monitoring of the voltage by means of voltage measurement, controllable contactors and a controller with software can be omitted. Thus, by means of simple components, passive overvoltage protection of the entire system is ensured, which requires no monitoring by means of software and incorporates no mechanical components.

FIG. 2 shows a characteristic curve for the diode 107 which, with effect from a given negative voltage, permits a voltage breakdown. Up to this point, the diode 107 carries virtually no current flux. The characteristic curve of the diode 107 comprises a breakdown region 205, a blocking region 203 and a conductive region 201. In the blocking region 203, the current initially rises slowly up to the blocking voltage. In the breakdown region 205 beyond the blocking voltage, the current flowing in the diode 107 rises abruptly.

Scaling can be executed for the purposes of application in the energy accumulator system 100, depending upon requirements and the field of application. The accumulator system 100 involves the incorporation of one or more diodes 107, operating with reverse bias, in the intermediate circuit 105 of an energy accumulator 101 which is connected to a converter 103 such as, for example, an inverter or an AC/DC converter.

A high-current configuration of the diode 107, with a permissible current greater than 60 A, is also possible, such that the resistor 109 can be replaced. As a result of the transient behavior of the converter 103 and the diode 107, upon the achievement of the diode breakdown voltage, a current only flows for a short time, for example less than 1 s. In this case, power is only applied to the diode 107 for a short time. In the event of a longer power take-up, cooling of the diode 107 can be provided, for example by means of a heat sink attached to the diode. In general, the employment of a plurality of diodes 107 in a series-connected arrangement is possible, to reduce the power applied per diode 107. A parallel-connected arrangement of a plurality of diodes 107 provides a further option for the reduction of the power applied per diode 107.

The voltage in the intermediate circuit 105 may lie between 500 V and 800 V. However, this voltage range can be extended, as required. Up-circuit of the energy accumulator 101, a DC voltage converter, e.g. a DC/DC actuator, can be employed, in order to achieve an initial increase in the voltage on the energy accumulator 101.

All the characteristics described and represented in conjunction with individual embodiments can be provided in different combinations, to permit the simultaneous achievement of the advantageous effects thereof. The scope of protection of the present disclosure is defined by the claims, and is not limited by the characteristics described in the description or represented in the figures.

What is claimed is:

1. An accumulator system for accumulating electrical energy, the system comprising:
an energy accumulator for generating a DC voltage;
a converter for converting the DC voltage into an AC voltage, connected to the energy accumulator via an intermediate circuit; and
a diode in the intermediate circuit connected in parallel with the energy accumulator and the converter, the diode having reverse bias to limit a voltage in the intermediate circuit.

2. The accumulator system as claimed in claim 1, further comprising a second diode limiting the voltage in the intermediate circuit, the second diode connected in parallel with the energy accumulator and the converter and having reverse bias.

3. The accumulator system as claimed in claim 1, wherein the diode comprises a semiconductor diode with a p-n junction or a Schottky diode.

4. The accumulator system as claimed in claim 1, further comprising a resistor connected in series with the diode.

5. The accumulator system as claimed in claim 4, wherein the resistor has a rating of between 0.1Ω and 100Ω.

6. The accumulator system as claimed in claim 1, wherein the diode comprises a high current diode with a permissible breakdown current greater than 60 A.

7. The accumulator system as claimed in claim 1, wherein the diode comprises a Zener diode, an avalanche diode, or a suppressor diode.

8. The accumulator system as claimed in claim 7, further comprising one or more additional Zener diodes connected in series with the Zener diode.

9. The accumulator system as claimed in claim 1, further comprising a DC voltage converter increasing the DC voltage of the energy accumulator.

10. The accumulator system as claimed in claim 1, further comprising a cooling arrangement removing heat from the diode.

11. The accumulator system as claimed in claim 10, wherein the diode is arranged in contact with a heat sink.

12. The accumulator system as claimed in claim 1, further comprising additional diodes connected in parallel.
